(19) United States
(12) Patent Application Publication
(10) Pub. No.: US 2026/0086528 A1
(43) Pub. Date: Mar. 26, 2026

(54) METHODS FOR CORRECTING PRE-COMPENSATION OF COUNTERSINK DIMENSIONS IN NUMERICALLY CONTROLLED COUNTERSINKING

(71) Applicant: CHENGDU AIRCRAFT INDUSTRIAL (GROUP) CO., LTD., Chengdu (CN)

(72) Inventors: Dongjun LIU, Chengdu (CN); Yan LI, Chengdu (CN); Jie LI, Chengdu (CN); Shuntao LIU, Chengdu (CN); Ying XIE, Chengdu (CN); Yu ZOU, Chengdu (CN); Long ZHANG, Chengdu (CN); Zhenbo MA, Chengdu (CN); Huabing HE, Chengdu (CN); Yunfeng AN, Chengdu (CN); Ruyi FENG, Chengdu (CN); Zhufeng WANG, Chengdu (CN); Jinlong LIU, Chengdu (CN)

(73) Assignee: CHENGDU AIRCRAFT INDUSTRIAL (GROUP) CO., LTD., Chengdu (CN)

(21) Appl. No.: 19/396,579

(22) Filed: Nov. 21, 2025

Related U.S. Application Data
(63) Continuation of application No. PCT/CN2023/130896, filed on Nov. 10, 2023.

(30) Foreign Application Priority Data
Jun. 6, 2023 (CN) 202310660571.7

(51) Int. Cl. G05B 19/18; G05B 19/404

(52) U.S. Cl. CPC G05B 19/182; G05B 19/404

(57) ABSTRACT

The present disclosure relates to a method for correcting pre-compensation of a countersink dimension in numerically controlled countersinking. The method includes: acquiring historical machining data of countersink hole machining of a plurality of countersink holes for products, and forming a historical dataset; performing a correlation analysis on the historical machining data of the countersink hole machining, and expanding a data volume of the historical dataset; performing a statistical analysis based on the expanded historical dataset to obtain a correction value for a pre-compensation value of a countersink hole machining dimension, and correcting a countersink hole dimension machining parameter.

### CROSS-REFERENCE TO RELATED APPLICATIONS

This application is a Continuation of International Application No. PCT/CN2023/130896, filed on Nov. 10, 2023, which claims priority to Chinese Patent Application No. 202310660571.7, filed on Jun. 6, 2023, the entire contents of each of which are hereby incorporated by reference.

### TECHNICAL FIELD

The present disclosure relates to the field of precision machining technology, and in particular relates to a method for correcting pre-compensation of a countersink dimension in numerically controlled countersinking.

### BACKGROUND

During the assembly of aircraft components, a large number of hole drilling and countersinking operations are required on a skin of an aircraft surface. Numerically controlled (NC) machining is widely used for the hole drilling and countersinking of the skin of the aircraft surface. In the NC hole drilling and countersinking process, countersink dimensions, such as countersink depth, are key indicators affecting the machining quality of the aircraft surface and have a significant impact on the assembly quality of the aircraft surface.

Currently, to ensure the dimensional accuracy of countersinking, techniques such as pre-compensation and real-time compensation are typically employed. In existing pre-compensation techniques, a pre-compensation value is usually determined through calculations based on theoretical parameters of the product, which often leads to significant discrepancies with actual product machining. Real-time compensation is generally also based on the pre-compensation value as a benchmark. If the determined pre-compensation value differs significantly from the actual requirements, achieving an effective compensation result using the real-time compensation technique becomes difficult.

Therefore, there is an urgent need to develop a method for correcting pre-compensation of a countersink dimension in numerically controlled countersinking to improve the accuracy of the countersink hole machining dimension.

### SUMMARY

One or more embodiments of the present disclosure provides a method for correcting pre-compensation of a countersink dimension in numerically controlled countersinking, comprising: acquiring historical machining data of countersink hole machining of a plurality of countersink holes for products, and forming a historical dataset; performing a correlation analysis on the historical machining data of the countersink hole machining, and expanding a data volume of the historical dataset; and performing a statistical analysis based on the expanded historical dataset to obtain a correction value for a pre-compensation value of a countersink hole machining dimension, and correcting a countersink hole dimension machining parameter. The historical machining data of the countersink hole machining of each of the plurality of countersink holes includes a preset machining value of a countersink hole dimension, the pre-compensation value of the countersink hole machining dimension, a countersink hole dimension deviation, an absolute countersink hole dimension deviation, a measured value of the countersink hole machining dimension, a countersink depth actual set value, a surface curvature at a position of the countersink hole on each of the products, and a maximum displacement of a pressure foot for the countersink hole. The method further includes: performing the correlation analysis on the historical machining data of the countersink hole machining by constructing a countersink hole correlation analysis unit; wherein the constructing a countersink hole correlation analysis unit includes: determining a correlation coefficient between the historical machining data of any two countersink holes of the plurality of countersink holes in the historical dataset; constructing a correlated countersink hole machining dataset; determining the correlation coefficient between the historical machining data of the any two countersink holes in the historical dataset by using a Pearson correlation coefficient between countersink hole dimension deviations of the any two countersink holes, a correlation coefficient based on surface curvatures at positions of the any two countersink holes on the product and maximum displacements of the pressure foot for the any two countersink holes, and a correlation coefficient between mean absolute countersink hole dimension deviations of the any two countersink holes.

Compared with the existing technologies, the present disclosure has the following advantages and beneficial effects:

The method provided in the present disclosure corrects the pre-compensation value for countersinking based on historical machining data of countersink hole machining. By analyzing the correlation between the machining data of countersink holes, and utilizing the correlation characteristics among a series of indicators from the countersink hole machining data-such as the surface curvature at the position of the countersink hole on the product, the maximum displacement of the pressure foot, the Pearson correlation coefficient of countersink dimension deviation, and the mean absolute countersink hole dimension deviation—the data volume used for pre-compensation correction analysis is expanded. This approach effectively mitigates the impact of insufficient historical data on analysis validity, improves the accuracy of pre-compensation value correction, and ensures the precision of countersink machining dimensions.

When performing correction analysis on the pre-compensation value for countersinking based on historical machining data, the present disclosure employs an analytical approach that relies on countersink hole-related data to analyze the normal distribution obeyed by the countersink hole dimension deviations. Mean estimation is performed based on the normal distribution. Using the countersink hole dimension machining tolerance in actual production as a constraint, the correction value for the pre-compensation value of the countersink hole machining dimension is calculated, thereby achieving the correction of the pre-compensation value. The analytical calculation manner is simpler, effectively meets the practical demands of NC machining for a large number of countersink holes on aircraft components, ensures machining accuracy, and reliably maintains the production cycle for the aircraft components.

### BRIEF DESCRIPTION OF THE DRAWINGS

In order to illustrate the technical solutions of the embodiments of the present disclosure more clearly, the drawings of the embodiments are briefly introduced below. It should be understood that the drawings referred to show only some embodiments of the present disclosure and therefore are not to be regarded as limiting the scope. A person of ordinary skill in the art may obtain other related drawings from these without creative effort.

FIG. 1 is a flowchart of an exemplary process of a method for correcting pre-compensation of a countersink dimension in numerically controlled countersinking according to some embodiments of the present disclosure;

FIG. 2 is a flowchart illustrating a process for correcting a countersink depth pre-compensation value in numerically controlled countersinking according to some embodiments of the present disclosure.

### DETAILED DESCRIPTION

In order to clarify the objectives, technical solutions, and advantages of embodiments of the present disclosure, the technical solutions in the embodiments of the present disclosure are described below with reference to the drawings in the embodiments of the present disclosure. Obviously, the described embodiments are only some embodiments of the present disclosure, rather than all embodiments.

The method of the present disclosure corrects the pre-compensation value for countersinking based on historical machining data of countersink hole machining. A large amount of historical data is required to improve the correction accuracy of the pre-compensation value. However, limited by the quantity of aircraft components being machined, the historical machining data of each countersink hole is relatively scarce when the production volume is low. Relying solely on the existing machining data of countersunk holes for analysis makes it difficult to reach a statistically significant magnitude, thus failing to achieve the purpose of the analysis. Therefore, it is necessary to expand the data required for the analysis.

To address the aforementioned problem, the present disclosure performs correlation analysis on the historical machining data and theoretical parameters among existing countersink holes, thereby expanding the current countersink hole machining data. This increases the volume of data used for analysis, ensures the validity of the analysis, and consequently improves the accuracy of the pre-compensation value and the precision of the countersink hole machining dimension.

Furthermore, based on the characteristics of countersinking, the distribution of actual machining data for NC countersink dimensions (e.g., the countersink depth) satisfies a normal distribution. Leveraging this characteristic, when correcting the pre-compensation value for the countersink hole machining dimension, the method employs a normal distribution analysis to estimate the range of machining dimension deviations. Under a set confidence interval and the required countersink hole dimension deviation tolerance, the corresponding correction value for the pre-compensation value is calculated, thereby achieving the correction of the pre-compensation value for the countersink hole machining dimension.

In other words, the method in the present disclosure achieves precise correction of the pre-compensation value by analyzing the mean and variance of the normal distribution of the machining dimension deviations for the countersink holes, based on historical machining data from the NC countersinking of aircraft components, thereby effectively improving the qualification rate of NC countersinking operations.

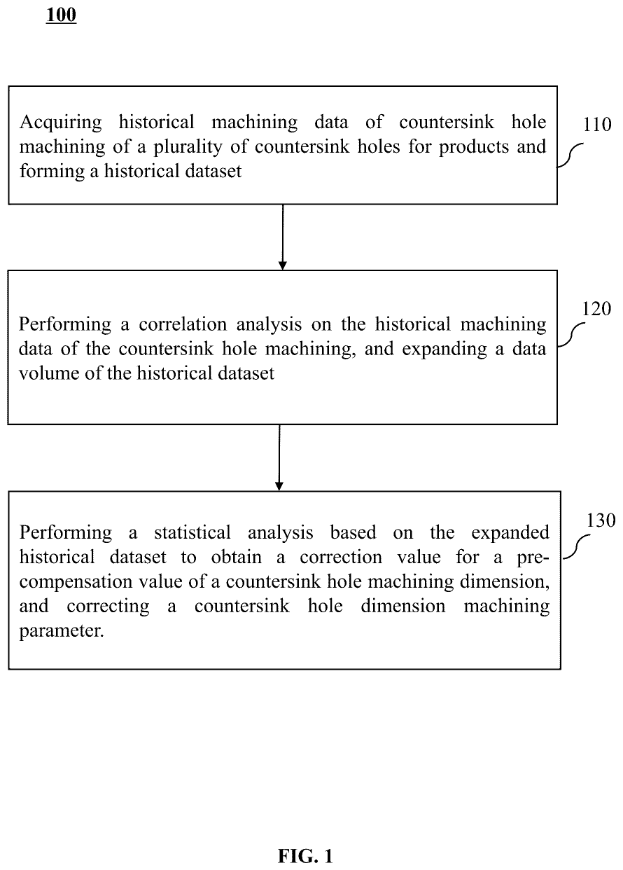

FIG. 1 is a flowchart of an exemplary process of a method for correcting pre-compensation of a countersink dimension in numerically controlled countersinking according to some embodiments of the present disclosure.

In some embodiments, as shown in FIG. 1, a process 100 may be executed by a processor, and the process 100 may include operations 110 to 130.

In some embodiments, the processor may include a central processing unit (CPU), an application-specific integrated circuit (ASIC), an application-specific instruction-set processor (ASIP), a physics processing unit (PPU), a digital signal processor (DSP), a microprocessor unit, a reduced instruction set computer (RISC), a microprocessor, or the like, or any combination thereof. In some embodiments, the processor may be local or remote. In some embodiments, the processor may be implemented on a cloud platform. Merely by way of example, the cloud platform may include a private cloud, a public cloud, a hybrid cloud, a community cloud, a distributed cloud, an on-premises cloud, a multi-tiered cloud, or the like, or any combination thereof.

In 110, acquiring historical machining data of countersink hole machining of a plurality of countersink holes for products and forming a historical dataset.

The countersink refers to a recess machined on a product surface with a countersink drill. The countersink drill refers to a drill bit used for machining a recess on a workpiece surface. The countersink drill may include a cylindrical countersink drill, a conical countersink drill, a combined countersink drill, or the like. The product refers to a workpiece to be machined. For example, the product may include an aircraft skin, a spacecraft cabin wall, an aluminum profile for a high-speed train body, an aluminum alloy inner panel of an automobile door, or the like.

The countersink hole machining refers to an operation of machining the product surface with the countersink drill. The countersink hole may include the countersink and a central hole of the countersink.

The historical machining data refers to data generated during previous countersink hole machining operations performed by the countersink drill on the product.

In some embodiments, the historical machining data includes a preset machining value of a countersink hole dimension, a pre-compensation value of a countersink hole machining dimension, a countersink hole dimension deviation, an absolute countersink hole dimension deviation, a measured value of the countersink hole machining dimension, a countersink depth actual set value, a surface curvature at a position of a countersink hole on the product, and a maximum displacement of a pressure foot for the countersink hole.

The preset machining value of the countersink hole dimension refers to a preset value for machining the product surface. The countersink hole dimension may include a countersink depth, or the like. The countersink depth refers to a depth of the countersink. In the present disclosure, the term countersunk hole dimension refers to a dimension of the countersunk hole resulting from the machining process, and is synonymous with the expression “countersunk hole machining dimension.”

In some embodiments, the preset machining value of the countersink hole dimension may be preset by a technician based on experience.

The pre-compensation value of the countersink hole machining dimension refers to a countersink hole dimension value used to offset system errors. For example, if in the historical machining data, the countersink hole dimension deviation is consistently smaller by a certain value on average during each countersink hole machining operation on the product (e.g., the actual countersink depth is 0.04 mm smaller than a preset countersink depth, i.e., the countersink hole dimension deviation is −0.04 mm), then the pre-compensation value of the countersink hole machining dimension may be the opposite number of the countersink hole dimension deviation (e.g., the countersink depth+0.04 mm).

In some embodiments, the pre-compensation value of the countersink hole machining dimension may be determined by the processor based on the historical machining data. For example, the processor may determine a mean value of countersink hole dimension deviations in the historical machining data, and designate the opposite number of the mean value as the pre-compensation value of the countersink hole machining dimension.

The countersink hole dimension deviation refers to a parameter that reflects a deviation between an actual machined countersink hole dimension and the preset machining value of the countersink hole dimension.

In some embodiments, the processor may determine a difference between the measured value of the countersink hole machining dimension after the countersink hole machining and the preset machining value of the countersink hole dimension as the countersink hole dimension deviation.

The absolute countersink hole dimension deviation refers to a parameter that reflects an absolute deviation between the actual machined countersink hole dimension and the preset machining value of the countersink hole dimension.

In some embodiments, the processor may determine an absolute value of the countersink hole dimension deviation as the absolute countersink hole dimension deviation.

The measured value of the countersink hole machining dimension refers to the actual measured countersink hole dimension after the countersink hole machining.

In some embodiments, the processor may acquire the measured value of the countersink hole machining dimension via a sensor. The sensor may include a laser displacement sensor, a Coordinate Measuring Machine (CMM), or the like.

The countersink depth actual set value refers to the countersink hole dimension that is finally executed.

In some embodiments, the processor may determine a sum of the preset machining value of the countersink hole dimension and the pre-compensation value of the countersink hole machining dimension as the countersink depth actual set value.

The surface curvature refers to a curvature at a center point of the countersink hole on the product. The surface curvature may include a Gaussian curvature and a principal curvature.

In some embodiments, the processor may determine the surface curvature at the position of the countersink hole on the product by using a computational tool. The computational tool may include Computer Aided Three-dimensional Interactive Application (CATIA), Unigraphics (UG), or the like.

The maximum displacement of the pressure foot refers to a parameter that reflects the amount of local elastic deformation of the product.

In some embodiments, the processor may determine a distance of a position of the pressure foot after the countersink hole machining relative to an initial position of the pressure foot before the countersink hole machining as the maximum displacement of the pressure foot. The pressure foot refers to a structural component that is pressed against the product surface during the countersink hole machining. For example, the pressure foot may be an annular or a boot-shaped structural member.

It may be understood that in countersinking, the pressure foot increases the stiffness of a machining equipment and improves the stability of the equipment. Typically, the pressure foot is applied against the product surface with a pressure, which may cause deformation of the product. The displacement of the pressure foot and the magnitude of the pressure during machining have significant effects on the dimensional accuracy of countersinking. The method of the preset disclosure selects the displacement of the pressure foot for the correction analysis of the countersink pre-compensation value. Meanwhile, considering the impact of the surface curvature at the position of the countersink hole on the product, curvature compensation is introduced to correct the pre-compensation value.

The historical dataset refers to a collection comprising a plurality of historical machining data.

In some embodiments, the processor may combine a plurality of historical machining data to form the historical dataset.

In 120, performing a correlation analysis on the historical machining data of the countersink hole machining, and expanding the data volume of the historical dataset.

In some embodiments, the processor may perform the correlation analysis on the historical machining data of the countersink hole machining by constructing a countersink hole correlation analysis unit.

The countersink hole correlation analysis unit refers to a module configured to perform the correlation analysis on the historical machining data of the countersink hole machining. In some embodiments, the countersink hole correlation analysis unit may be integrated within the processor or communicatively coupled to the processor. The countersink hole correlation analysis unit may be implemented in firmware, software, or any combination thereof.

In some embodiments, the countersink hole correlation analysis unit may be configured to determine a correlation coefficient between the historical machining data of any two countersink holes of the plurality of countersink holes in the historical dataset.

For example, the processor may establish a countersink hole correlation coefficient calculation equation by using a Pearson correlation coefficient between countersink hole dimension deviations of the any two countersink holes, a correlation coefficient based on surface curvatures at positions of the any two countersink holes on the product and maximum displacements of the pressure foot for the any two countersink holes, and a correlation coefficient between mean absolute countersink hole dimension deviations of the any two countersink holes, and calculate the correlation coefficient between the countersink hole machining data of the any two countersink holes based on the equation.

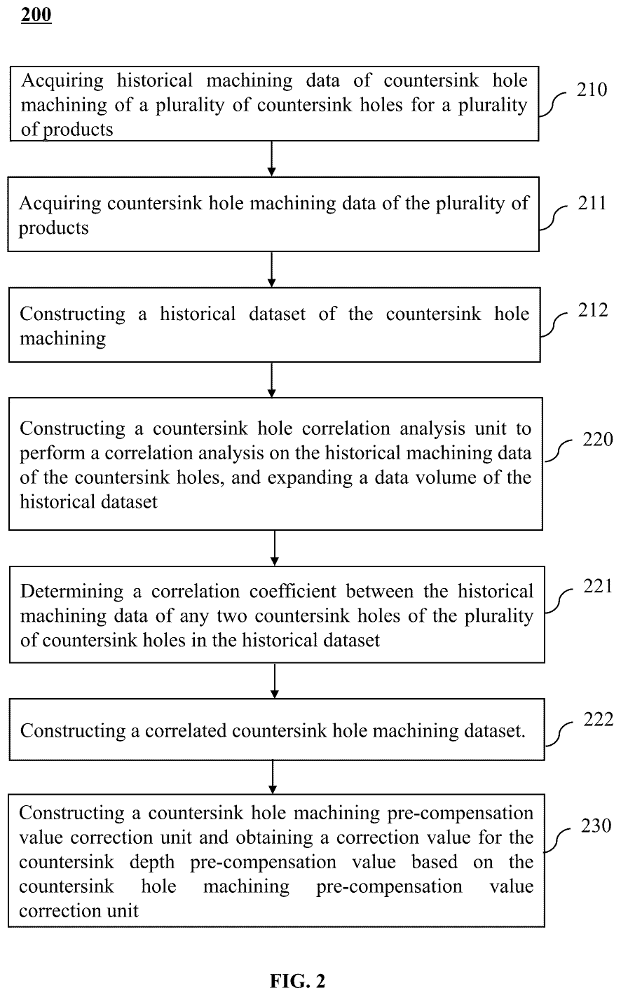

More descriptions regarding the countersink hole correlation coefficient calculation equation may be found in FIG. 2 and the relevant descriptions thereof.

In some embodiments, the processor may construct a correlated countersink hole machining dataset based on the correlation coefficient between the historical machining data of any two countersink holes of the plurality of countersink holes, and expand the data volume of the historical dataset based on the correlated countersink hole machining dataset in a plurality of ways. The correlated countersink hole machining dataset refers to a set that contains the historical machining data of a plurality of countersink holes with identifiers. The historical machining data of each of the countersink holes in the correlated countersink hole machining dataset exhibits a high correlation coefficient with the historical machining data of a specific countersink hole.

For example, for a countersink hole a, the processor may identify one or more countersink holes j (j=1, 2, . . . ,m) whose historical machining data have a correlation coefficient with that of the countersunk hole a exceeding a correlation coefficient threshold. The processor may then add the identifiers of the countersunk holes j and their corresponding historical machining data into the correlated countersink hole machining dataset for the countersunk hole a. The processor may add the historical machining data corresponding to the countersunk hole identifiers in the set of correlated countersunk hole machining data into the historical dataset, thereby expanding the data volume of the historical dataset. The correlation coefficient threshold is a parameter for determining whether the historical machining data between countersink holes has a high correlation. In some embodiments, the correlation coefficient threshold may be preset by technical personnel based on experience.

In 130, performing a statistical analysis based on the expanded historical dataset to obtain a correction value for the pre-compensation value of the countersink hole machining dimension, and correcting a countersink hole dimension machining parameter.

The countersink hole dimension machining parameter refers to a parameter used for the actual machining of the countersink hole on the product. For example, the countersink hole dimension machining parameter may be a sum of the preset machining value of the countersink hole dimension and the pre-compensation value of the countersink hole machining dimension.

In some embodiments, the processor may perform the statistical analysis on the expanded historical dataset through a countersink hole machining pre-compensation value correction unit. For example, the processor may perform one or more of maximum likelihood estimation, analysis of variance (ANOVA), and regression analysis on the expanded historical dataset through the countersink hole machining pre-compensation value correction unit.

In some embodiments, the processor may construct the countersink hole machining pre-compensation value correction unit to obtain a mean and a standard deviation of a mean estimation of any countersink hole; determine a confidence interval of a mean dimension deviation of the countersink hole at a preset confidence level; and obtain the correction value for the pre-compensation value of the countersink hole machining dimension based on a countersink hole dimension machining tolerance.

The countersink hole machining pre-compensation value correction unit refers to a module configured to determine the correction value for the pre-compensation value of the countersink hole machining dimension. In some embodiments, the countersink hole machining pre-compensation value correction unit may be integrated within the processor or communicatively coupled to the processor. The countersink hole machining pre-compensation value correction unit may be implemented in firmware, software, or any combination thereof.

The preset confidence level refers to a pre-defined confidence level. In some embodiments, the preset confidence level may be preset by technical personnel based on experience.

The countersink hole dimension machining tolerance refers to an allowable error in the countersink hole machining. In some embodiments, the countersink hole dimension machining tolerance may be preset by technical personnel based on experience.

Since the pre-compensation value of the countersink hole machining dimension may be the opposite number of the countersink hole dimension deviation, and the countersink hole dimension deviation is not a fixed value, performing the statistical analysis on the expanded historical dataset is essentially equivalent to performing the statistical analysis on the countersink hole dimension deviations in the historical dataset. The mean estimate refers to an estimate of the population mean of the countersink hole dimension deviations. The mean of the mean estimate refers to the value of the mean estimate itself.

More descriptions regarding the correction value for the pre-compensation value of the countersink hole machining dimension may be found in FIG. 2 and the relevant descriptions thereof.

In some embodiments of the present disclosure, by constructing the countersink hole machining pre-compensation value correction unit to obtain the mean and the standard deviation of the mean estimate for any countersink hole, calculating the confidence interval, and determining the correction value for the pre-compensation value of the countersink hole machining dimension, the allowable fluctuation range specified by design can be taken into account. This approach helps avoid over-compensation leading to countersink breakthrough or rivet head sinking, thereby improving the qualification rate of the countersink hole machining and reducing the probability of rework.

The correction value refers to a parameter configured to correct the countersink hole dimension machining parameter.

In some embodiments, the processor may further determine the correction value for the pre-compensation value of the countersink hole machining dimension in a plurality of ways based on the confidence interval of the mean of the countersink hole at the preset confidence level and the countersink hole dimension machining tolerance. For example, the processor may determine a maximum tolerance value of the countersink hole dimension machining tolerance based on the confidence level and the standard deviation, and determine the confidence interval of the mean of the countersink hole at the preset confidence level based on the mean and the standard deviation of the mean estimate. The processor may compare a sum of the maximum tolerance value and the pre-compensation value of the countersink hole machining dimension with a difference between the countersink hole dimension machining tolerance and a sum of the maximum tolerance value, the pre-compensation value of the countersink hole machining dimension, and an upper limit of the confidence interval. The processor may take the smaller of the two values as the correction value for the pre-compensation value of the countersink hole machining dimension.

In some embodiments, the processor may add the correction value to the countersink hole dimension machining parameter to achieve correction of the countersink hole dimension machining parameter.

In some embodiments, the processor may further set a sum of the preset machining value of the countersink hole dimension, the pre-compensation value of the countersink hole machining dimension, and the correction value as the countersink depth actual set value.

In some embodiments, correcting the countersink hole dimension machining parameter includes correcting a countersink depth machining dimension.

The countersink depth machining dimension refers to a parameter for the countersink depth used in the actual machining of the countersunk hole on the product. For example, the countersink depth machining dimension may be a sum of the preset machining value of the countersink hole dimension and the pre-compensation value of the countersink hole machining dimension.

In some embodiments, the processor may add the correction value to the countersink depth machining dimension to achieve correction of the countersink depth machining dimension.

In some embodiments of the present disclosure, correcting the countersink hole dimension machining parameter includes correcting the countersink depth machining dimension, which can directly apply the compensation manner to the critical countersink hole dimension, thereby improving the qualification rate for the countersink depth in the countersink hole machining.

In some embodiments, when determining a correction value for a countersink depth pre-compensation value, the correction value for the countersink depth pre-compensation value is calculated based on a countersink depth upper deviation limit.

The countersink depth upper deviation limit refers to a maximum allowable countersink depth for the product. For example, the countersink depth upper deviation limit may be an upper limit value of the countersink hole dimension machining tolerance.

In some embodiments, the countersink depth upper deviation limit may be determined by technical personnel by consulting an upper tolerance value table (e.g., for countersunk riveted joints, composite material countersinks, Boeing BAC 5009, etc.).

In some embodiments, the processor may determine a maximum value of the countersink depth upper deviation limit based on the preset confidence level and the standard deviation of the mean estimate. For example, the processor may determine the maximum value of the countersink depth upper deviation limit by multiplying the two-tailed quantile z_{α/2} of the standard normal distribution at the preset confidence level 1-a by the standard deviation σ of the mean estimate.

In some embodiments, the processor may compare a sum of the maximum value of the countersink depth upper deviation limit and the pre-compensation value of the countersink hole machining dimension with a difference between the pre-compensation value of the countersink hole machining dimension and a sum of the maximum value of the pre-compensation value of the countersink hole machining dimension, the pre-compensation value of the countersink hole machining dimension, and the upper limit of the confidence interval, and take the smaller of the two values as the correction value.

More descriptions regarding the correction value for the countersink depth pre-compensation value may be found in FIG. 2 and the relevant descriptions thereof.

In some embodiments of the present disclosure, calculating the correction value for the countersink depth pre-compensation value based on the countersink depth upper deviation limit can reduce the probability of the countersink depth exceeding the countersink depth upper deviation limit, decrease the safety margin, and avoid excessive compensation.

In some embodiments of the present disclosure, by performing the correlation analysis on the historical machining data of the countersink hole machining, expanding the data volume of the historical dataset, performing the statistical analysis to obtain the correction value for the pre-compensation value of the countersink hole machining dimension, and correcting the countersink hole dimension machining parameter, the sample variance in the historical dataset can be reduced and the signal-to-noise ratio of the historical dataset can be improved. This approach reduces the probability of the countersink depth exceeding the tolerance, mitigates the impact of insufficient historical data on analysis effectiveness, enhances the accuracy of pre-compensation value correction, and ensures the precision of the countersink hole machining dimension.

It should be noted that in countersinking of aircraft components, the countersink depth is a key evaluation indicator of countersinking quality. The method for correcting pre-compensation of the countersink dimension in numerically controlled countersinking according to the present disclosure is described below using the correction of the countersink depth pre-compensation value in numerically controlled countersinking as an example.

FIG. 2 is a flowchart illustrating a process for correcting a countersink depth pre-compensation value in numerically controlled countersinking according to some embodiments of the present disclosure.

In some embodiments, as shown in FIG. 2, process 200 may be performed by a processor, and process 200 may include operations 210 to 230.

In 210, acquiring historical machining data of countersink hole machining of a plurality of countersink holes for a plurality of products.

In 211, acquiring countersink hole machining data of the plurality of products (also referred to as countersink machined products).

For example, the countersink hole machining data of a countersink hole on a product includes a preset countersink depth machining value dₛ, a countersink depth pre-compensation value d_{c}, a countersink depth measured value dₘ, a surface curvature C at a position of the countersink hole on the product, and a maximum displacement S of a pressure foot for the countersink hole.

Based on the above parameters, the following may be obtained for each countersink hole: a countersink depth deviation dₑ=dₘ−dₛ, an absolute countersink depth deviation

$${d}_{e}^{′} = {d}_{m} - {d}_{s} - {d}_{c} ,$$

and a countersink depth actual set value dₐ=dₛ−d_{c}.

In 212, constructing a historical dataset of the countersink hole machining.

For example, the historical machining data of n countersink machined products may be acquired, where each of the n countersink machined products contains m countersink holes. The constructed historical dataset of countersink hole machining is expressed as

$$U = \{ < {d}_{s , ij} , {d}_{c , ij} , {d}_{m , ij} , {d}_{e , ij} , {d}_{e , ij}^{′} , {d}_{a , ij} , {C}_{ij} , {S}_{ij} > \vert i = 1 , … , n j = 1 , … , m \} .$$

Here, i denotes the identifiers for the corresponding countersink machined products, and j denotes the identifiers for the countersink holes.

In 220, constructing a countersink hole correlation analysis unit to perform a correlation analysis on the historical machining data of the countersink holes, and expanding a data volume of the historical dataset.

In 221, determining a correlation coefficient between the historical machining data of any two countersink holes of the plurality of countersink holes in the historical dataset.

For example, the processor may calculate the correlation coefficient between the historical machining data of any two countersink holes (e.g., a countersink hole a and a countersink hole j) based on the historical machining data in the historical dataset. The processor may determine the correlation coefficient of the historical machining data of the two countersink holes through Equation (1):

$${R}_{aj} = ( \frac{{\sum }_{i = 1}^{n} ( {d}_{e , ia} - \overline{{d}_{e , a}} ) ( {d}_{e , ij} - \overline{{d}_{e , j}} )}{\sqrt{{\sum }_{i = 1}^{n} {( {d}_{e , ia} - \overline{{d}_{e , a}} )}^{2}} \sqrt{{\sum }_{i = 1}^{n} {( {d}_{e , ij} - \overline{{d}_{e , j}} )}^{2}}} + ( 1 - \frac{\vert {c}_{a} {s}_{a} - {c}_{j} {s}_{j} \vert}{\vert {c}_{a} {s}_{a} + {c}_{j} {s}_{j} \vert} ) ) ( 1 - \frac{\vert {\sum }_{i = 1}^{n} {d}_{e , ia}^{′} - {\sum }_{i = 1}^{n} {d}_{e , ij}^{′} \vert}{\vert {\sum }_{i = 1}^{n} {d}_{e , ia}^{′} + {\sum }_{i = 1}^{n} {d}_{e , ij}^{′} \vert} ) . \qquad ( 1 )$$

In Equation (1), a, j=1, . . . , m, d_{e,ia} denotes a countersink depth deviation of the countersink hole a on an i-th product, d̅_̅{̅e̅,̅a̅}̅ denotes a mean countersink depth actual set value of the countersink hole a, d_{e,ij} denotes a countersink depth deviation of the countersink hole j on the i-th product, d̅_̅{̅e̅,̅j̅}̅ denotes a mean countersink depth actual set value of the countersink hole j,

$${d}_{e , ia}^{′}$$

denotes an absolute countersink depth deviation of the countersink hole a on the i-th product, and

$${d}_{e , ij}^{′}$$

denotes an absolute countersink depth deviation of the countersink hole j on the i-th product. The first term denotes a Pearson correlation coefficient between the countersink hole dimension deviations of the two countersink holes a and j; the second term denotes a correlation coefficient based on surface curvatures at positions of the two countersink holes a and j on the product and displacements of the pressure foot for the two countersink holes a and j; and the third term denotes a correlation coefficient between mean absolute countersink hole dimension deviations of the two countersink holes a and j. The correlation coefficient between the countersink hole a and the countersink hole j may be calculated through Equation (1).

In 222, constructing a correlated countersink hole machining dataset.

For example, the processor may set a correlation coefficient threshold as ε. For any countersink hole a(a=1, . . . , m), the processor may construct the correlated countersink hole machining dataset as: RSₐ={j|Rₐⱼ>ε,j=1, . . . , m}.

At this point, the construction of the countersink hole correlation analysis unit is completed. The current countersink hole machining dataset is expanded based on the countersink hole correlation analysis unit to increase the data volume of the countersink hole machining dataset, thereby obtaining an expanded dataset.

In 230, constructing a countersink hole machining pre-compensation value correction unit, and obtaining a correction value for the countersink depth pre-compensation value based on the countersink hole machining pre-compensation value correction unit.

According to the theory of mean-estimation, for any countersink hole a, the following may be calculated from ∀j∈RSₐ:

$${μ}_{a} = \frac{\sum j ∈ R {S}_{a} {\sum }_{i = 1}^{n} {d}_{e , ij}^{′}}{N} and {σ}_{a} = \sqrt{\frac{\sum j ∈ R {S}_{a} {\sum }_{i = 1}^{n} {( {d}_{e , ij}^{′} - {μ}_{a} )}^{2} )}{N}} ,$$

wherein N=n*card (RSₐ) denotes a total count of samples related to the countersink hole a, μₐ denotes a mean of a mean estimate of countersink hole a, σₐ denotes a standard deviation of the mean estimate of countersink hole a, and the absolute countersink depth deviation of the countersink hole a follows a normal distribution

$${X}_{a} ∼ ( {μ}_{a} , \frac{{σ}_{a}^{2}}{N} ) .$$

For a given a, the confidence interval for the mean of the countersink hole a at a confidence level of 1−a is obtained as

$$[ {μ}_{a} - {z}_{α / 2} \frac{σ}{\sqrt{N}} , {μ}_{a} + {z}_{α / 2} \frac{σ}{\sqrt{N}} ] .$$

Since the countersink depth upper deviation limit is a key evaluation indicator for the countersink depth, let ξ denotes the required value for the countersink depth upper deviation limit. At the confidence level of 1−α, the maximum achievable value of the countersink depth upper deviation limit is z_{α/2}σ, and the mean also takes the upper limit of the confidence interval. The processor obtains the correction value for the countersink depth pre-compensation value through Equation (2):

$${d}_{c}^{′} = min ( ξ - ( {μ}_{a} + {Z}_{\frac{α}{2}} \frac{σ}{\sqrt{N}} + {Z}_{\frac{α}{2}} σ + {d}_{c} ) , ( {μ}_{a} + {Z}_{\frac{α}{2}} \frac{σ}{\sqrt{N}} + {d}_{c} ) ) . \qquad ( 2 )$$

In some embodiments, the processor uses Equation (2) to control the fluctuation of the countersink depth, so that the countersink depth does not exceed the countersink depth upper deviation limit, and the correction value for the countersink depth pre-compensation value is taken as the smaller of the two potential values in the equation.

In some embodiments, the processor may correct the countersink depth machining dimension based on the obtained correction value. For example, the processor may obtain the countersink depth actual set value through Equation (3):

$${d}_{a} = {d}_{s} + {d}_{c} + {d}_{c}^{′} . \qquad ( 3 )$$

The foregoing merely illustrates preferred embodiments of the present disclosure and is not intended to impose any limitation on the present disclosure. Any simple modification or equivalent variation made to the above embodiments in reliance on the technical essence of the present disclosure shall fall within the scope of protection of the present disclosure.

Finally, it should be noted that the above embodiments are merely intended to illustrate the technical solutions of the present disclosure, rather than limiting them. Although the present disclosure has been described in detail with reference to the foregoing embodiments, those skilled in the art should understand that modifications can still be made to the technical solutions recorded in the foregoing embodiments, or some or all of the technical features can be equivalently replaced; and such modifications or replacements do not cause the essential nature of the corresponding technical solutions to depart from the scope of the technical solutions of the embodiments of the present disclosure.

What is claimed is:

1. A method for correcting pre-compensation of a countersink dimension in numerically controlled countersinking, comprising:
acquiring historical machining data of countersink hole machining of a plurality of countersink holes for products, and forming a historical dataset;
performing a correlation analysis on the historical machining data of the countersink hole machining, and expanding a data volume of the historical dataset;
performing a statistical analysis based on the expanded historical dataset to obtain a correction value for a pre-compensation value of a countersink hole machining dimension, and correcting a countersink hole dimension machining parameter;
wherein the historical machining data of the countersink hole machining of each of the plurality of countersink holes includes a preset machining value of a countersink hole dimension, the pre-compensation value of the countersink hole machining dimension, a countersink hole dimension deviation, an absolute countersink hole dimension deviation, a measured value of the countersink hole machining dimension, a countersink depth actual set value, a surface curvature at a position of the countersink hole on each of the products, and a maximum displacement of a pressure foot for the countersink hole;
performing the correlation analysis on the historical machining data of the countersink hole machining by constructing a countersink hole correlation analysis unit; wherein the constructing a countersink hole correlation analysis unit includes:
determining a correlation coefficient between the historical machining data of any two countersink holes of the plurality of countersink holes in the historical dataset;
constructing a correlated countersink hole machining dataset;
determining the correlation coefficient between the historical machining data of the any two countersink holes in the historical dataset by using a Pearson correlation coefficient between countersink hole dimension deviations of the any two countersink holes, a correlation coefficient based on surface curvatures at positions of the any two countersink holes on the product and maximum displacements of the pressure foot for the any two countersink holes, and a correlation coefficient between mean absolute countersink hole dimension deviations of the any two countersink holes.

2. The method for correcting pre-compensation of the countersink dimension in numerically controlled countersinking of claim 1, wherein the correcting a countersink hole dimension machining parameter includes correcting a countersink depth machining dimension.

3. The method for correcting pre-compensation of the countersink dimension in numerically controlled countersinking of claim 1, wherein the performing a statistical analysis based on the expanded historical dataset to obtain a correction value for a pre-compensation value of a countersink hole machining dimension, and correcting a countersink hole dimension machining parameter, includes:
constructing a countersink hole machining pre-compensation value correction unit, and acquiring a mean and a standard deviation of a mean estimation of any countersink hole;
determining a confidence interval of the mean of the countersink hole at a preset confidence level; and
obtaining the correction value for the pre-compensation value of the countersink hole machining dimension based on a countersink hole dimension machining tolerance.

4. The method for correcting pre-compensation of the countersink dimension in numerically controlled countersinking of claim 3, wherein a correction value for a countersink depth pre-compensation value is determined through calculation by taking a countersink depth upper deviation limit as a baseline.
